(19) United States
(12) Patent Application Publication
(10) Pub. No.: US 2016/0037081 A1
(43) Pub. Date: Feb. 4, 2016

(54) Method and Apparatus for Dynamic Image Content Manipulation

(71) Applicant: SUPPONOR OY, Espoo (FI)

(72) Inventor: Francisco Roberto Peixoto Socal, Espoo (FI)

(21) Appl. No.: 14/774,488

(22) PCT Filed: Mar. 12, 2014
(86) PCT No.: PCT/EP2014/054878

§ 371 Date: Sep. 10, 2015

(30) Foreign Application Priority Data
Mar. 13, 2013 (GB) 1304511.7

(51) Int. Cl. H04N 5/265; H04N 5/247; H04N 5/272

(52) U.S. Cl. CPC H04N 5/265; H04N 5/2723; H04N 5/247

(57) ABSTRACT

For dynamic image content manipulation, a target area key signal KA defines a target area of a first program signal PGM1 which is to be modified. A difference key signal KD is generated as a combination of the target area key signal K_{A} and a graphics key signal K_{G} which defines coverage over a clean feed image signal CF by a graphics fill signal F_{G} to give the first program signal PGM1. A difference fill signal FD is derived according to image differences between the first program signal PGM1 and the clean feed image signal CF. In one example, at least one modified program signal M-PGM is produced by combining the first program signal PGM1 with an alternate content fill signal F_{A} according to the difference key signal K_{D} and the difference fill signal F_{D}.

### BACKGROUND

1. Field

The present invention relates generally to a system for manipulating the content of an image. More particularly, the present invention relates to a method and apparatus which detects a target area in one or more regions of an image, and which may replace the target area with alternate content. In some examples, the present invention relates to a dynamic image content replacement method and apparatus suitable for use with live television broadcasts.

2. Related Art

In the related art, one or more target areas within a video image are defined and then replaced with alternate images appropriate to specific viewer groups or geographical regions. For example, billboards at a ground or arena of a major sporting event are observed as part of a television broadcast, and these target areas are electronically substituted by alternate images that are more appropriate for a particular country or region. In particular, such a system is useful to create multiple television feeds each having different electronically generated advertisement content which is tailored according to an intended audience.

A problem arises in that television feeds typically have multiple image layers which are mixed together. For example, original images of a sports event are overlaid with one or more graphics layers providing additional information for the viewer relating to the current score, teams, athletes or various statistics. There is a difficulty in dynamically modifying the video image signals in a way which is accurate and photo-realistic for the viewer, particularly due to the complexity of the added graphics layers. There is a further difficulty in producing a suitable number of feeds each having differing content (e.g. a billboard in the original images is modified to carry advert 1 for country 1, while advert 2 is added for region 2, and so on). This problem is particularly relevant for an event of ‘worldwide’ interest which is to be broadcast to a large number of countries or regions where it is desired to dynamically modify the video images appropriate to each specific audience.

WO2001/58147 (Rantalainen) describes a method for modifying television video images, wherein a billboard or other visible object is identified with non-visible electromagnetic radiation, such as infra-red light.

WO2009/074710 (Rantalainen) describes a method for modifying television video images by determining a shared area where the intended target area is overlapped by added graphics (e.g. graphics overlays) with a predetermined graphics percentage of coverage and substitute content is added according to the residual percentage of coverage not covered by the added graphics. However, this system relies upon access to original images (the clean feed) and requires a relatively large amount of information to be carried through the transmission chain.

WO2012/143,596 (Suontama) describes a method of detecting which graphics elements, if any, have been added at any given time in frames of a video signal. This system is useful in situations where the original clean feed is not available but does not fully address the problems noted herein.

Considering the related art, there is still a difficulty in providing a reliable and effective mechanism for defining a target area within a video image where content is to be replaced. Further, there is a need to improve the transmission of signals through different stages of a transmission chain (e.g. to reduce bandwidth), especially where a content substitution function is performed downstream from a content detection function. Further still, there is a desire to improve the flexibility for configuring the system, so that the system may be adapted and installed more readily with other existing video processing equipment.

It is now desired to provide an apparatus and method which will address these, or other, limitations of the current art, as will be appreciated from the discussion and description herein.

### SUMMARY

According to the present invention there is provided a system, apparatus and method as set forth in the appended claims. Other features of the invention will be apparent from the dependent claims, and the description which follows.

In one example there is provided a method for use in dynamic image content manipulation, the method comprising: (a) providing a graphics key signal K_{G} which defines coverage over a clean feed image signal CF by a graphics fill signal F_{G}; (b) receiving a first program signal PGM1 wherein the graphics fill signal F_{G} has been added to the clean feed image signal CF according to the graphics key signal K_{G}; (c) providing a target area key signal K_{A} defining a target area of the first program signal PGM which is to be modified; (d) generating a difference key signal K_{D} as a combination of the target area key signal K_{A} and the graphics key signal K_{G}; (e) deriving a difference fill signal F_{D} according to image differences between the first program signal PGM1 and the clean feed image signal CF; and (f) outputting the difference fill signal F_{D} and the difference key signal K_{D}.

In one example, the method may further include (g) producing at least one modified program signal M-PGM by combining the first program signal PGM1 with an alternate content fill signal F_{A} according to the difference key signal K_{D} and the difference fill signal F_{D}.

In one example, the step (g) comprises producing a plurality of modified program signals M-PGMi by combining the first program signal PGM1 with each of a plurality of alternate content fill signals F_{Ai}, respectively.

In one example, the step (f) comprises outputting the difference fill signal F_{D} and the difference key signal K_{D} as an auxiliary image signal stream and carrying the auxiliary image signal stream together with the first program signal PGM to a remote content substitution station which performs the step (g). In one example, the step (f) further comprises compressing the difference fill signal F_{D} and/or the difference key signal K_{D}.

In one example, the step (e) comprises providing the difference fill signal F_{D} according to the image differences in shared areas where the target area key signal K_{A} and the graphics key signal K_{G} both indicate semi-transparency.

In one example, the difference fill signal F_{D} contains image content only in the shared areas where the target area key signal K_{A} and the graphics key signal K_{G} are both greater than zero and less than one hundred percent.

In one example, the difference key signal K_{D} is described by the equation:

K_{D}=(1−K_{G})·K_{A}

whereby K_{D} contains null values in areas where K_{A} indicates that no additional content is to be added and contains null values in areas where K_{G} indicates full coverage by graphics overlays of the graphics fill signal F_{G}.

In one example, the target area key signal K_{A} and the graphics key signal K_{G} are each defined by numerical percentage values applied to each of a plurality of pixels in regions of an image area.

In one example, the difference fill signal F_{D} is expressed by the equation:

F_{D}=K_{D}·(PGM−CF)

whereby only areas of image differences which are semi-transparent are carried in the fill difference signal F_{D}.

In one example, the step (g) further comprises replacing the modified program signal M-PGM by the first program signal PGM1 without any modification as a fallback condition.

In one example, the step (a) further comprises performing a graphics detection operation which derives the graphics fill signal F_{G} and/or the graphics key signal K_{G}.

In one example, the step (e) comprises deriving the fill difference signal F_{D} using the graphics fill signal F_{G}, wherein the fill difference signal F_{D} is represented by the equation:

F_{D}=−K_{A}·K_{G}(PGM−F_{G})

In one example, there is provided an apparatus for use in a dynamic image content manipulation system, the apparatus comprising: a target area determining unit which is arranged to provide a target area key signal K_{A} defining a target area of a first program signal PGM which is to be modified; a key combination unit which is arranged to obtain a graphics key signal K_{G} which defines coverage over a clean feed image signal CF by a graphics fill signal F_{G}; and wherein the key combination unit is further arranged to generate a difference key signal K_{D} as a combination of the target area key signal K_{A} and the graphics key signal K_{G}, and to derive a difference fill signal F_{D} according to image differences between the first program signal PGM1 and the clean feed image signal CF, and to output the difference fill signal F_{D} and the difference key signal K_{D}.

In one example, the apparatus is arranged to operate according to any of the methods mentioned herein.

In one example, there is provided a preserving mixer unit which is arranged to produce at least one modified program signal M-PGM by combining the first program signal PGM1 with an alternate content fill signal F_{A} according to the difference key signal K_{D} and the difference fill signal F_{D}.

In one example there is provided a tangible non-transient computer readable medium having recorded thereon instructions which when executed cause a computer to perform the steps of any of the methods defined herein.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIG. 1 is a schematic diagram showing a graphics overlay mixing operation;

FIG. 2 is a schematic diagram showing a content substitution operation;

FIG. 3 is a schematic diagram showing an example embodiment of the system considered herein;

FIG. 4 is a schematic overview of a television broadcasting system in which example embodiments may be applied;

FIG. 5 is a schematic diagram showing an example apparatus in more detail; and

FIG. 6 is a schematic flow diagram of an example method.

### DETAILED DESCRIPTION

The example embodiments will be described with reference to a content replacement system, or more generally an apparatus and method for image content manipulation, which may be used to replace content within television video images and particularly to provide photo-realistic replacement of a billboard for live television broadcasts. However, the methods and apparatus described herein may be applied in many other specific implementations, which may involve other forms of video images or relate to other subjects of interest, as will be apparent to persons skilled in the art from the teachings herein.

Firstly, a graphics mixing operation and a content substitution operation will be explained as background to the example embodiments.

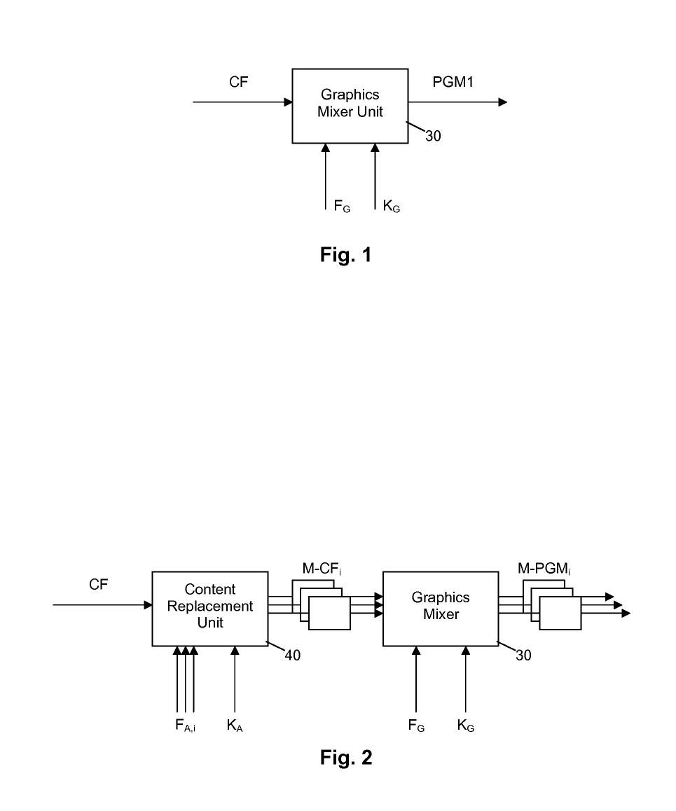

FIG. 1 is a schematic diagram showing a graphics overlay mixing operation, which is suitably performed by a graphics mixer unit 30, wherein a graphics overlay image signal F_{G} is added to a video image signal CF. The mixing operation is controlled by a graphics key signal K_{G}. A program video image signal PGM1 is produced.

In this example, the incoming video image signal may take any suitable form and for convenience will be termed herein a clean feed image signal CF. The outgoing video signal PGM1 likewise may take any suitable form and is suitably called a program feed signal, also termed a dirty feed signal (DF). The graphics overlay image signal, also called a graphics fill signal F_{G}, is mixed with the clean feed picture signal CF according to the graphics key signal K_{G}. The graphics key signal K_{G} determines a graphics percentage of coverage (graphics %) which defines the relative transparency of the graphics fill signal F_{G} when mixed with the clean feed picture signal CF. Thus, the graphics fill signal F_{G} is suitably an image signal which corresponds to one or more parts or regions of the image area of the clean feed picture signal CF. The graphics fill signal F_{G} is mixed with the clean feed picture signal CF in a proportion which is defined by the percentage of coverage (graphics %) in the graphics key signal K_{G}. The graphics key signal K_{G} suitably defines the graphics percentage of coverage for each pixel, or each group of pixels, within the relevant image area which is to be modified by the graphics overlay.

The mixing operation of FIG. 1 can be expressed by the equation:

PGM=Mix (CF, F_{G}, K_{G})

These signals each suitably represent images or video image frames constructed by arrays of pixels such as a two-dimensional grid. Each additional graphics layer can thus be considered as a combination of the fill and the key components. The fill represents the visual content of the image (e.g. colour or greyscale pixel values), while the key represents the relative transparency (density) of that image layer. The key is suitably a form of numerical transparency coefficient. The terms graphics layer has been used here for convenience, but it will be appreciated that the graphics layer may contain any suitable image content. Multiple graphics layers may be applied sequentially over an original or initial image layer.

FIG. 2 illustrates a content substitution operation which may be performed by a content replacement unit 40. An alternate image content signal F_{A} is used to modify an incoming video signal CF according to a target area key signal K_{A}. A modified clean feed video image signal M-CF is produced. The content substitution operation may need to be repeated several times, using different alternate images F_{A,i}, in order to produce respective modified image signals M-CF₁, M-CF₂ . . . M-CFᵢ where i is a positive integer. The content substitution operation may be described by the equation:

M-CFᵢ=Mix (CF, F_{A,i}, K_{A})

Further, as shown in FIG. 2, the modified clean feed image signals M-CFᵢ are each input to the graphics mixing operation of FIG. 1 as described above so that the one or more graphics layers may be added to each modified signal to produce a corresponding plurality of modified program signals M-PGMᵢ The graphics mixing operation can thus be described by the equation:

M-PGMᵢ=Mix (M-CFᵢ, F_{G}, K_{G})

Notably, the content substitution operation is typically performed at an early stage of the transmission chain where access to the clean feed image signals is available, and typically needs to be closely integrated with other equipment which produces the clean feed and which performs the graphics mixing operation. Further, each of the modified program signals M-PGMᵢ are carried through the system, which increases the complexity and load of the transmission chain.

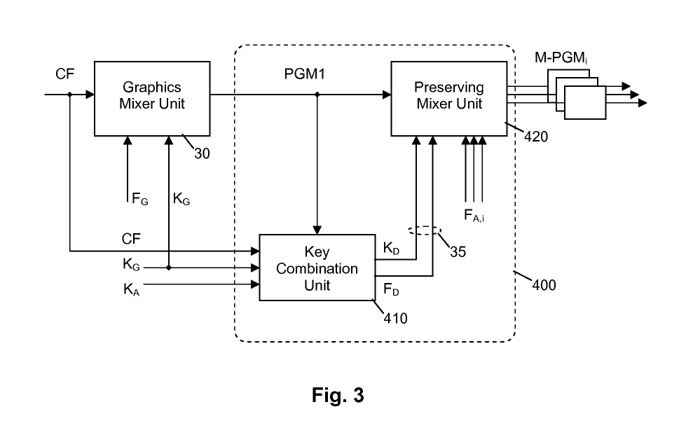

FIG. 3 is a schematic diagram showing an example embodiment of the system considered herein. In particular, FIG. 3 shows a content replacement system 400 comprising a key combination unit 410 and a preserving mixer unit 420.

In this example, the target area key signal K_{A} defines a target area of the video signal which is to be modified or replaced. Typically, the non-target areas of the original video signal are to be left unaltered, while the target area key signal K_{A} identifies those regions or portions which are to be modified. The target area key signal K_{A} may be produced, for example, by using an infra-red detector to identify a subject in a scene shown in the video images.

In the example embodiments, the target area key signal K_{A} is suitably defined as a numerical percentage value which will be applied to each pixel or group of pixels in the image area. For example, zero percent indicates that the original image remains as originally presented whilst one hundred percent indicates that the original image is to be completely replaced at this position. Further, the target area key signal K_{A} may define partial replacement by a percentage greater than zero and less than one hundred, indicating that the original image will persist proportionately at that position and thus a semi transparent replacement or modification is performed with the original image still being partially visible. For example, such semi-transparent portions are useful in transition regions at a boundary of the target area to improve a visual integration of the alternate content with the original images.

In the example embodiments, the key combination unit 410 is arranged to generate a difference key signal K_{D} and a difference fill signal F_{D}. The difference key signal K_{D} generally represents a combination of the target area key signal K_{A} and the graphics key signal K_{G} as will be explained in more detail below. The difference fill signal F_{D} generally represents differences in the image content between the first program signal PGM1 and the clean feed picture signal CF. As described above, these differences are mainly due to the addition of the graphics overlays according to the graphics fill signal F_{G} and the graphics key signal K_{G}.

The difference fill signal F_{D} is suitably restricted and only applies in shared areas where the target area key signal K_{A} and the graphics key signal K_{G} both define semi transparency. As noted above, the target area key signal K_{A} and the graphics key signal K_{G} are both suitably expressed as percentages. Thus, the difference fill signal F_{D} contains image content only in these shared areas where the target area key signal K_{A} and the graphics key signal K_{G} are both greater than zero and less than one hundred percent.

The difference fill signal F_{D} and the difference key signal K_{D} may together form an intermediate signal stream or auxiliary signal stream 35. The auxiliary signal steam 35 is suitable for transmitting to a subsequent stage in a transmission chain. In example embodiments, the auxiliary signal steam 35 is suitably provided along with the first program signal PGM1. The auxiliary signal stream 35 allows the first program signal PGM1 to be modified by introducing the alternate content.

In the example embodiments, the first program signal PGM1 is modified by combining the first program signal PGM1 with the alternate content fill signal F_{A} with reference to the difference key signal K_{D} and the difference fill signal F_{D} to produce a modified program signal M-PGM.

FIG. 3 also shows a further example embodiment, wherein multiple differing versions of the alternate content fill signal F_{A1}, F_{A2}, F_{A3} are provided. Generically this can be considered as F_{Ai} where i is a positive integer. Using the same difference fill signal F_{D} and difference key signal K_{D} together with the respective alternate content fill signal F_{A}, the example embodiments are able to produce many different modified program signals M-PGMⱼ.

In the example embodiments, the difference key signal K_{D} is described by the equation:

K_{D}=(1−K_{G})·K_{A}

Thus, K_{D} is zero in all areas where K_{A} is zero. Further, K_{D} is zero in all areas where K_{G} is 100 percent. Advantageously, K_{D} contains non-zero values only for those portions of the image area where K_{G} is less than one and K_{A} is greater than zero, thus indicating that both K_{G} and K_{A} represent semi-transparent areas. The difference key signal K_{D} thus carries meaningful information only in the area of interest and is suitable for high compression by standard image or video compression methods.

The difference fill signal F_{D} is suitably represented by the equation:

F_{D}=K_{D}·(PGM−CF)=[(1−K_{G})·K_{A}]·[(PGM−CF)]

In practical embodiments, only relatively small areas, such as transitional border areas, are semi-transparent, and the area where both K_{A} and K_{G} are semi-transparent will be even smaller still. Thus the difference fill signal F_{D} carries information in a relatively small area of the image and can be highly compressed by standard image compression or video compression techniques.

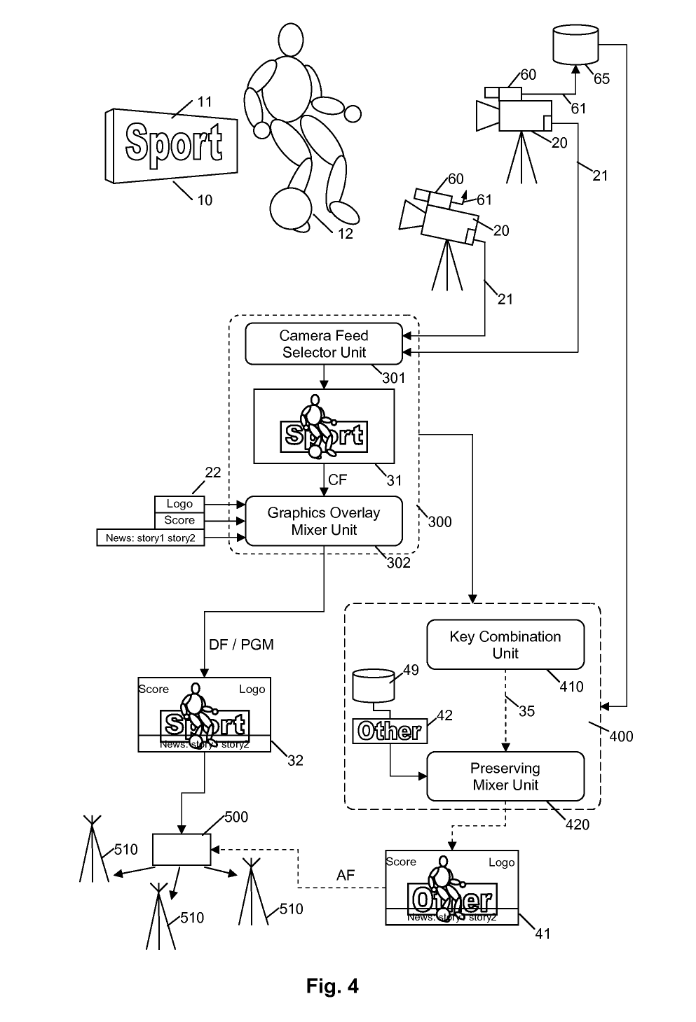

FIG. 4 is a schematic overview of a television broadcasting system in which example embodiments may be applied. FIG. 4 includes one or more observed subjects 10, one or more cameras 20, a vision mixing system 300, a content replacement system 400, and a broadcast delivery system 500. It will be appreciated that the television broadcasting system of FIG. 4 has been simplified for ease of explanation and that many other specific configurations will be available to persons skilled in the art.

In the illustrated embodiment, the observed subject of interest is a billboard 10 which carries original content 11 such as an advertisement (in this case the word “Sport”). The billboard 10 and the original content 11 are provided to be seen by persons in the vicinity. For example, many billboards are provided at a sporting stadium or arena visible to spectators present at the event. In one example, the billboards 10 are provided around a perimeter of a pitch so as to be prominent to spectators in the ground and also in video coverage of the event.

A television camera 20 observes a scene in a desired field of view to provide a respective camera feed 21. The field of view may change over time in order to track a scene of interest. The camera 20 may have a fixed location or may be movable (e.g. on a trackway) or may be mobile (e.g. a hand-held camera or gyroscopic stabilised camera). The camera 20 may have a fixed lens or zoom lens, and may have local pan and/or tilt motion. Typically, several cameras 20 are provided to cover the event or scene from different viewpoints, producing a corresponding plurality of camera feeds 21.

The billboard 10 may become obscured in the field of view of the camera 20 by an intervening object, such as by a ball, person or player 12. Thus, the camera feed 21 obtained by the camera 20 will encounter different conditions at different times during a particular event, such as (a) the subject billboard moving into or out of the field of view, (b) showing only part of the subject (c) the subject being obscured, wholly or partially, by an obstacle and/or (d) the observed subject being both partially observed and partially obscured. Hence, there is a difficulty in accurately determining the position of the desired subject 10 within the relevant video images, and so define a masking area or target area where the content within the video images is to be enhanced or modified, such as by being electronically replaced with alternate image content.

As shown in FIG. 4, the captured camera feeds 21 are provided, whether directly or indirectly via other equipment, to the vision mixing system 300, which in this example includes a camera feed selector unit 301 and a graphics overlay mixer unit 302. Typically, the vision mixer 300 is located in a professional television production environment such as a television studio, a cable broadcast facility, a commercial production facility, a remote truck or outside broadcast van (‘OB van’) or a linear video editing bay.

The vision mixer 300 is typically operated by a vision engineer to select amongst the camera feeds 21 at each point in time to produce a clean feed (CF) 31, also known as a director's cut clean feed. The vision mixing system 300 may incorporate or be coupled to a graphics generator unit (not shown) which provides a plurality of graphics layers 22 such as a station logo (“Logo”), a current score (“Score”) and a pop-up or scrolling information bar (“News: story1 story2”). Typically, the one or more graphics layers 22 are applied over the clean feed 31 to produce a respective dirty feed (DF) 32. The dirty feed is also termed a program feed PGM as discussed above.

A separate graphics computer system may produce the graphics layers 22, and/or the graphics layers 22 may be produced by components of the vision mixer 300. The graphics layers 22 may be semi-transparent and hence may overlap the observed billboard 10 in the video images. The graphics layers 22 may be dynamic, such as a moving logo, updating time or score information, or a moving information bar. Such dynamic graphics layers 22 give rise to further complexity in defining the desired masking area (target area) at each point in time.

The dirty feed DF 32 is output to be transmitted as a broadcast feed, e.g. using a downstream broadcast delivery system 500. The feed may be broadcast live and/or is recorded for transmission later. The feed may be subject to one or more further image processing stages, or further mixing stages, in order to generate the relevant broadcast feed, as will be familiar to those skilled in the art. The broadcast delivery system 500 may distribute and deliver the broadcast feed in any suitable form including, for example, terrestrial, cable, satellite or Internet delivery mechanisms to any suitable media playback device including, for example, televisions, computers or hand-held devices. The broadcast feed may be broadcast to multiple viewers simultaneously, or may be transmitted to users individually, e.g. as video on demand.

The content replacement unit 400 is arranged to identify relevant portions of video images corresponding to the observed subject of interest. That is, the content replacement unit 400 suitably performs a content detection function to identify target areas or regions within the relevant video images which correspond to the subject of interest. The content replacement unit 400 may also suitably perform a content substitution function to selectively replace the identified portions with alternate content, to produce an alternate feed AF 41 which may then be broadcast as desired. In another example, the content substitution function may be performed later by a separate content substitution unit (also called a ‘remote adder’ or ‘local inserter’). In which case, the intermediate feed 35 may be carried by the system as an auxiliary signal stream.

In more detail, the content replacement unit 400 receives suitable video image feeds, and identifies therein a target area relevant to the billboard 10 as the subject of interest. The received images may then be modified so that the subject of interest 10 is replaced with alternate content 42, to produce amended output images 41. In this illustrative example, a billboard 10, which originally displayed the word “Sport”, now appears to display instead the alternate content 42, as illustrated by the word “Other”. In this example, the content replacement unit 400 is coupled to receive the incoming video images from the vision mixer 300 and to supply the amended video images as an alternate feed AF to the broadcast system 500.

In one example embodiment, the content replacement unit 400 may be provided in combination with the vision mixer 300. As one example, the content replacement unit 400 might be embodied as one or more software modules which execute using hardware of the vision mixer 300 or by using hardware associated therewith.

In another example embodiment, the content replacement unit 400 may be provided as a separate and stand-alone piece of equipment, which is suitably connected by appropriate wired or wireless communications channels to the other components of the system as discussed herein. In this case, the content replacement apparatus 400 may be provided in the immediate vicinity of the vision mixer 300, or may be located remotely. The content replacement apparatus 400 may receive video images directly from the vision mixer 300, or via one or more intermediate pieces of equipment. The input video images may be recorded and then processed by the content replacement apparatus 400 later, and/or the output images may be recorded and provided to other equipment later.

In the example embodiments, a high value is achieved when images of a sporting event, such as a football or soccer match, are shown live to a large audience. The audience may be geographically diverse, e.g. worldwide, and hence it is desirable to create multiple different alternate broadcast feeds AF for supply to the broadcasting system 500 to be delivered in different territories using local delivery broadcast stations 510, e.g. country by country or region by region. In a live event, the content replacement apparatus 400 should operate reliably and efficiently, and should cause minimal delay.

In the example embodiments, the alternate content 42 comprises one or more still images (e.g. JPEG image files) and/or one or more moving images (e.g. MPEG motion picture files). As another example, the alternate content 42 may comprise three-dimensional objects in a 3D interchange format, such as COLLADA, Wavefront .OBJ or Autodesk .3DS file formats, as will be familiar to those skilled in the art.

The alternate content 42 is suitably prepared in advance and is recorded on a storage medium 49 coupled to the content replacement apparatus 400. Thus, the content replacement apparatus 400 produces one or more alternate feeds AF where the observed subject 10, in this case the billboard 10, is replaced instead with the alternate content 42. Ideally, the images within the alternate feed AF should appear photo-realistic, in that the ordinary viewer normally would not notice that the subject 10 has been electronically modified. Hence, it is important to accurately determine a masking area defining the position of the billboard 10 within the video images input to the content replacement apparatus 400. Also, it is important to identify accurately when portions of the observed subject 10 have been obscured by an intervening object 12 such as a player, referee, etc. Notably, the intervening object or objects may be fast-moving and may appear at different distances between the camera 20 and the subject 10. Further, it is desirable to produce the alternate feed 41 containing the alternate content 42 in a way which is more agreeable for the viewer, and which is less noticeable or obtrusive. Thus, latency and synchronisation need to be considered, as well as accuracy of image content manipulation.

The example content replacement apparatus 400 is arranged to process a plurality of detector signals 61. In one example embodiment, the detector signals 61 may be derived from the video images captured by the camera 20, e.g. using visible or near-visible light radiation capable of being captured optically through the camera 20, wherein the camera 20 acts as a detector 60. In another example embodiment, one or more detector units 60 are provided separate to the cameras 20.

The detector signals 61 may be derived from any suitable wavelength radiation. The wavelengths may be visible or non-visible. In the following example embodiment, the detector signals 61 are derived from infra-red wavelengths, and the detector signals 61 are infra-red video signals representing an infra-red scene image. Another example embodiment may detect ultra-violet radiation. In one example embodiment, polarised visible or non-visible radiation may be detected. A combination of different wavelength groups may be used, such as a first detector signal derived from any one of infra-red, visible or ultra-violet wavelengths and a second detector signal derived from any one of infra-red, visible or ultra-violet wavelengths.

In the illustrated example embodiment, one or more detectors 60 are associated with the camera 20. In the example embodiment, each camera 20 is co-located with at least one detector 60. The or each detector 60 may suitably survey a field of view which is at least partially consistent with the field of view of the camera 20 and so include the observed subject of interest 10. The detector field of view and the camera field of view may be correlated. Thus, the detector signals 61 are suitably correlated with the respective camera feed 21. In the example embodiment, the detector signals 61 are fed to the content replacement apparatus 400. In the example embodiment, the detector signals 61 are relayed live to the content replacement apparatus 400. In another example embodiment, the detector signals 61 may be recorded into a detector signal storage medium 65 to be replayed at the content replacement apparatus 400 at a later time.

As an example, the one or more detectors 60 may be narrow-spectrum near infra-red (NIR) cameras. The detector 60 may be mounted adjacent to the camera 20 so as to have a field of view consistent with the camera 20. Further, in some embodiments, the detectors 60 may optionally share one or more optical components with the camera 20.

The detector 60 may be arranged to move with the camera 20, e.g. to follow the same pan & tilt motions. In the example embodiments, the cameras 20 may provide a telemetry signal which records relevant parameters of the camera, such as the focal length, aperture, motion and position. In one example, the telemetry signal includes pan and tilt information. The telemetry may also include zoom information or zoom information may be derived from analysing the moving images themselves. The telemetry may be used, directly or indirectly, to calculate or otherwise provide pan, roll, tilt and zoom (PRTZ) information. The camera telemetry signal may be passed to the content replacement system 400, whether directly or via an intermediate storage device, in order to provide additional information about the field of view being observed by each camera 20.

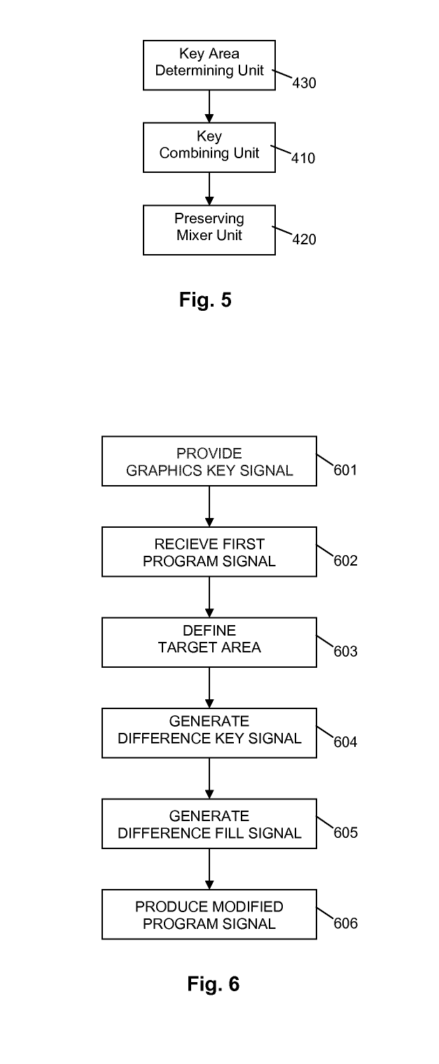

FIG. 5 shows an example embodiment of the content replacement system 400 in more detail. The content replacement system suitably includes a key combination unit 410, a preserving mixer unit 420, and a target area determining unit 430.

The target area determining unit 430 suitably generates the target area key signal K_{A} based on the detector signals and/or with reference to the telemetry signals as discussed above. The target area key signal K_{A} defines a target area of the relevant image signal, called here the first program signal PGM, which is to be modified.

The key combination unit 410 is arranged to receive, or to otherwise derive, the graphics key signal K_{G} which defines coverage over a clean feed image signal CF by a graphics fill signal F_{G}. The graphics fill signal F_{G} is added to the clean feed image signal CF according to the graphics key signal K_{G} to provide the first program signal PGM1. This addition is suitably performed by an upstream stage prior to the key combination unit 410.

The key combination unit 410 is further arranged to generate a difference key signal K_{D} as a combination of the target area key signal K_{A} and the graphics key signal K_{G}. The example key combination unit 410 is further arranged to derive a difference fill signal F_{D} according to differences in appearance between the first program signal PGM1 and the clean feed image signal CF. The difference fill signal F_{D} and the difference key signal K_{D} are suitably output or recorded onto a durable storage medium, ready for onward transmission and use subsequently.

The preserving mixer unit 420 is arranged to produce at least one modified program signal M-PGM by combining the first program signal PGM1 with an alternate content fill signal F_{A} according to the difference key signal K_{D} and the difference fill signal F_{D}. The preserving mixer is suitably physically remote from the key combination unit 410 and is coupled thereto by a communication channel.

FIG. 6 is a schematic flow diagram of an example method which is suitable for use in for use in a dynamic image content manipulation process as discussed herein. In particular, the content of an image is modified is some way by introducing alternate or additional image content. A dynamic method is preferred in that the image content may change significantly from frame to frame, such as for a live television broadcast which selects amongst multiple cameras with varying image contents. The step 601 provides a graphics key signal K_{G} which defines coverage over the original image signal or clean feed image signal CF by a graphics fill signal F_{G}. The step 602 includes receiving a first program signal PGM1 wherein the graphics fill signal F_{G} has been added to the clean feed image signal CF according to the graphics key signal K_{G}. The step 603 includes providing a target area key signal K_{A} defining a target area of the first program signal PGM which is to be modified. The step 604 includes generating a difference key signal K_{D} as a combination of the target area key signal K_{A} and the graphics key signal K_{G}. The step 605 includes deriving a difference fill signal F_{D} according to image differences between the first program signal PGM1 and the clean feed image signal CF. The step 605 includes outputting the difference fill signal F_{D} and the difference key signal K_{D}. The step 606 includes producing at least one modified program signal M-PGM by combining the first program signal PGM1 with an alternate content fill signal F_{A} according to the difference key signal K_{D} and the difference fill signal F_{D}.

The described embodiments have several important advantages. As shown above, the difference fill signal F_{D} and the difference key signal K_{D} are distributed alongside the first program signal PGM1. Thus, bandwidth requirements are reduced, by reducing the components of the intermediate signals that need to be sent between different stations or phases of the system. Further, the intermediate signals described herein contain a minimal amount of information and can be highly compressed. Further, these intermediate signals maintain high visual quality with minimum degradation even when compressed. These advantages are particularly valuable when different video processing stages are performed in different geographical locations and the intermediate signals must be sent over transmission links with limited bandwidth capacity. In particular, the intermediate signals are now suitable for distribution using satellite links, for example, or Internet links with limited capacity. As a result it is now possible to extend the system into geographical regions which have an interested audience but a limited, or still developing, network infrastructure.

The example system is highly robust. In the event that a signal failure occurs then the first program signal PGM1 can be displayed without any modification. This preserves an acceptable viewing experience, which is important particularly for live television broadcast. In other words, the failsafe mode presents images which are still valid and relevant to the viewer without any visual disturbance.

As a further advantage, the system described herein is well adapted to be integrated with existing commercial equipment. As noted above, the first program signal PGM1 can be generated by any suitable mechanism and, in itself, this stage is left outside the scope of the system. As a result, the system is more flexible to receive the first program signal PGM1 which may have been modified in multiple phases already. This minimises commercial and logistic constraints toward integrating the system with the existing equipment. Further, the inputs required of the system have been minimised, thus reducing the number of signals which need to be extracted from the existing equipment in order to produce the intermediate signal stream discussed above.

As a further advantage, the system allows the alternate content to be semi-transparent, whilst preserving semi-transparency of previously added graphics overlays. This provides a richer and more appealing visual result in the modified program signals M-PGM. As a result, viewers are more likely to find the added alternate content visually appealing and integrated with the original signal. Thus, a better photo-realistic result can be achieved.

For simplicity, the method described above has been illustrated with grey scale images or video signals. However, the skilled person can readily extend this description to colour signals in any suitable colour space such as RGB or YUV.

Some standard video formats such as SDI use eight or ten bit integer values to represent pixel values, but only a subset of the full eight or ten bit ranges are actually valid pixel values. Thus, practical implementations may consider restricting the range of outputs from the equations as described above so as to stay within the valid pixel ranges. In some practical embodiments a chroma sub-sampling scheme may be used and the method may be adapted accordingly.

It will be appreciated that the difference fill signal F_{D} derived from the equations above may contain negative values for some pixels. Meanwhile, standard video formats typically represent pixel values with unsigned values. Thus, a mapping mechanism may be employed to map to or from signed and unsigned values, such as by adding an offset to the original pixel values derived from the difference fill signal.

In some practical circumstances, the graphics fill signal F_{G} and or the graphics key signal K_{G} may not be known or may not be supplied as an input to the system. In this situation, it is possible to perform a graphics detection stage which derives these signals, suitably based on the program signal PGM and the clean feed signal CF. A suitable graphics detection mechanism is described, for example, in WO2012/143596 entitled DETECTION OF GRAPHICS ADDED TO A VIDEO SIGNAL, the content of which is incorporated herein in its entirety.

It is further possible that the original clean feed signal CF is not available in some practical circumstances. In this situation, the fill difference signal F_{D} can be derived using the graphics fill signal F_{G} instead (which itself may be supplied or may be derived as described above). As an example, the fill difference signal F_{D} in this case may be described as:

F_{D}=−K_{A}·K_{G}(PGM−F_{G})

There is a problem particularly when graphics layers have already been added to an original video signal. These graphics layers may be semi-transparent and thus the original video image will still appear beneath the added graphics layers. When it is then desired to change or modify the image content in the original video signal, whilst preserving the graphics that have been added. Considering the graphics as a topmost visual layer and the original content as a bottommost layer, it is desired to change the bottommost layer whilst preserving the graphics of the topmost layer.

The system described above allows those topmost graphics layers to be inserted first following existing processes, with traditional keying methods or mixing operations, such as those which may be implemented in commercial video switching and mixing equipment or image manipulation software applications. The result of those first layers in order of processing and topmost layers in order of visual appearance remains valid and relevant, independent of the additional manipulations or content replacement that have been inserted in later in time and intermediate in visual appearance between the original background image and the topmost graphics layers. This can be considered a form of ‘graphics preservation’. The graphics layer (or layers) which have already been added to an image are preserved, even though another layer (i.e. the alternate content) is now added subsequently in time but at a visually intermediate position.

At least some embodiments of the invention may be constructed, partially or wholly, using dedicated special-purpose hardware. Terms such as ‘component’, ‘module’ or ‘unit’ used herein may include, but are not limited to, a hardware device, such as a Field Programmable Gate Array (FPGA) or Application Specific Integrated Circuit (ASIC), which performs certain tasks. Alternatively, elements of the invention may be configured to reside on an addressable hardware storage medium and be configured to execute on one or more processors. Thus, functional elements of the invention may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Further, although the example embodiments have been described with reference to the components, modules and units discussed herein, such functional elements may be combined into fewer elements or separated into additional elements.

Although a few example embodiments have been shown and described, it will be appreciated by those skilled in the art that various changes and modifications might be made without departing from the scope of the invention, as defined in the appended claims.

1.-15. (canceled)

16. A method for use in dynamic image content manipulation, the method comprising:
providing a graphics key signal (K_{G}) which defines coverage over a clean feed image signal (CF) by a graphics fill signal (F_{G});
receiving a first program signal (PGM1) wherein the graphics fill signal (F_{G}) has been added to the clean feed image signal (CF) according to the graphics key signal (K_{G});
providing a target area key signal (K_{A}) defining a target area of the first program signal (PGM1) which is to be modified;
generating a difference key signal (K_{D}) as a combination of the target area key signal (K_{A}) and the graphics key signal (K_{G});
deriving a difference fill signal (F_{D}) according to image differences between the first program signal (PGM1) and the clean feed image signal (CF); and
outputting the difference fill signal (F_{D}) and the difference key signal (K_{D}).

17. The method of claim 16, further comprising:
producing at least one modified program signal (M-PGM) by combining the first program signal (PGM1) with an alternate content fill signal (FA) according to the difference key signal (K_{D}) and the difference fill signal (F_{D}).

18. The method of claim 17, wherein producing at least one modified program signal (M-PGM) comprises producing a plurality of modified program signals (M-PGMi) by combining the first program signal (PGM1) with each of a plurality of alternate content fill signals (F_{Ai}), respectively.

19. The method of claim 17, wherein outputting the difference fill signal (F_{D}) and the difference key signal (K_{D}) comprises outputting the difference fill signal (F_{D}) and the difference key signal (K_{D}) as an auxiliary image signal stream and carrying the auxiliary image signal stream together with the first program signal (PGM) to a remote content substitution station that produces the modified program signal (M-PGM).

20. The method of claim 17, wherein outputting the difference fill signal (F_{D}) and the difference key signal (K_{D}) further comprises compressing the difference fill signal (F_{D}) and/or the difference key signal (K_{D}).

21. The method of claim 16, wherein deriving a difference fill signal (F_{D}) comprises providing the difference fill signal (F_{D}) according to the image differences in shared areas where the target area key signal (K_{A}) and/or the graphics key signal (K_{G}) indicate semi-transparency.

22. The method of claim 16, wherein the difference fill signal (F_{D}) contains image content only in the shared areas where the target area key signal (K_{A}) and the graphics key signal (K_{G}) are both greater than zero and less than one hundred percent.

23. The method of claim 16, wherein the difference key signal (K_{D}) is described by the equation:
K_{D}=(1−K_{G})·K_{A}
whereby (K_{D}) contains null values in areas where (K_{A}) indicates that no additional content is to be added and contains null values in areas where K_{G} indicates full coverage by graphics overlays of the graphics fill signal (F_{G}).

24. The method of claim 21, wherein the target area key signal (K_{A}) and the graphics key signal (K_{G}) are each defined by numerical coefficient values applied to each of a plurality of pixels in regions of an image area.

25. The method of claim 16, wherein the difference fill signal (F_{D}) is expressed by the equation:
F_{D}=K_{D}·(PGM−CF)
whereby only areas of image differences which are semi-transparent are carried in the fill difference signal (F_{D}).

26. The method of claim 16, wherein producing at least one modified program signal (M-PGM) further comprises replacing the modified program signal (M-PGM) by the first program signal PGM1 without any modification as a fallback condition.

27. The method of claim 16, wherein providing a graphics key signal (K_{G}) further comprises performing a graphics detection operation which derives the graphics fill signal (F_{G}) and/or the graphics key signal (K_{G}).

28. The method of claim 16, wherein deriving a difference fill signal (F_{D}) comprises deriving the fill difference signal F_{D} using the graphics fill signal (F_{G}), wherein the fill difference signal (F_{D}) is represented by the equation:
F_{D}=−K_{A}·K_{G}(PGM−F_{G})

29. A dynamic image content manipulation system, comprising:
a target area determining unit which is arranged to provide a target area key signal (KA) defining a target area of a first program signal (PGM1) which is to be modified;
a key combination unit which is arranged to obtain a graphics key signal (KG) which defines coverage over a clean feed image signal (CF) by a graphics fill signal (FG); and
wherein the key combination unit is further arranged to generate a difference key signal (K_{D}) as a combination of the target area key signal (K_{A}) and the graphics key signal (K_{G}), and to derive a difference fill signal (F_{D}) according to image differences between the first program signal (PGM1) and the clean feed image signal (CF), and to output the difference fill signal (F_{D}) and the difference key signal (K_{D}).

30. The system of claim 29, further comprising:
a preserving mixer unit which is arranged to produce at least one modified program signal (M-PGM) by combining the first program signal (PGM1) with an alternate content fill signal (F_{A}) according to the difference key signal (K_{D}) and the difference fill signal (F_{D}).

31. A dynamic image content manipulation system, comprising a processing circuit configured to:
generate a target area key signal (KA) defining a target area of a first program signal (PGM1) which is to be modified;
generate a difference key signal (K_{D}) as a combination of the target area key signal (K_{A}) and a graphics key signal (K_{G}) that defines coverage over a clean feed image signal (CF) by a graphics fill signal (FG);
generate a difference fill signal (F_{D}) according to image differences between the first program signal (PGM1) and the clean feed image signal (CF); and
output the difference fill signal (F_{D}) and the difference key signal (K_{D}).

32. The system of claim 31, wherein the processing circuit is further configured to generate at least one modified program signal (M-PGM) by combining the first program signal (PGM1) with an alternate content fill signal (F_{A}) according to the difference key signal (K_{D}) and the difference fill signal (F_{D}).
